(19) United States
(12) Patent Application Publication
(10) Pub. No.: US 2013/0080592 A1
(43) Pub. Date: Mar. 28, 2013

(54) RECOMMENDER SYSTEM FOR A CONTENT SERVER BASED ON SECURITY GROUP MEMBERSHIP

(71) Applicants: Robin Budd, Seattle, WA (US); Gerald Carter, Dadeville, AL (US)

(72) Inventors: Robin Budd, Seattle, WA (US); Gerald Carter, Dadeville, AL (US)

(21) Appl. No.: 13/288,703

(22) Filed: Nov. 3, 2011

Related U.S. Application Data
(60) Provisional application No. 61/538,525, filed on Sep. 23, 2011.

(51) Int. Cl. G06F 15/173; G06F 15/16

(52) U.S. Cl. 709/219; 709/226

(57) ABSTRACT

Methods, systems, and techniques for recommending content using a measure of security group based similarity are provided. Embodiments described herein provide enhanced computer- and network-based methods, techniques, and systems for a recommender system, e.g., for content servers, that uses security group membership as the basis for determining user similarity. In particular, upon request for a recommendation, an enhanced content provider, through the use of the Security Based Recommender (SBR), provides indications of similar content based upon the security group membership of the requestor. The SBR determines similar content by determining what content was accessed by others within the security group membership of the requester. The recommendations may be ranked or filtered or combined with other types of recommendations, such as social network filtering, statistical based filtering, or the like.

### TECHNICAL FIELD

The present disclosure relates to methods, techniques, and systems for providing recommendations and, in particular, to methods, techniques, and systems for providing recommendations using security group membership.

### BACKGROUND

Organizations frequently find it useful to share information between users. They often employ “content servers” such as file servers and Web servers to make this information accessible. Unstructured data (“files”) stored in traditional file servers, Web servers and other content servers constitute the largest percentage of data in many enterprises. According to some sources, this type of information is also the fastest growing category of data.

File servers may be general purpose computing systems running file-sharing services for example, Microsoft Windows Server, or dedicated devices such as those manufactured by NetApp. Web servers may also be general purpose computing systems for example, based on Apache Web Server or Microsoft IIS, or special-purpose computing systems such as the Wordpress blogging system or Microsoft Sharepoint. These servers allow users to create, modify and delete information of interest to multiple users. Over time, however, these servers frequently end up containing massive amounts of data making it difficult to find (e.g., determine, locate, etc.) information of interest.

Although traditional file and Web servers typically offer mechanisms for organizing data, for example, the use of directories and hyperlinks, it is increasingly difficult to find data of interest when the volume and growth of such information is large.

Content indexers, for example Google Enterprise Search or Microsoft Search, can scan files in content servers and create full-text indices that speed up content-based searches, for example, a search of all files that contain “employee birthdays,” but they don't identify whether the information found is up-to-date or in-use by other people in the company. File and Web servers are frequently full of old, out-of-date, information that is no longer accurate or relevant. Distinguishing between useful and useless data in file servers is a difficult problem.

To solve this problem, some systems, for example, media storage or shopping services, frequently offer “recommender” systems, sometimes just referred to as “recommenders,” to suggest data of interest to their users. These recommender systems are often based on the access patterns of other users deemed to be similar to the searching user. Similarity is sometimes based on common social group memberships (such as friends in social networking applications) or on similar activity patterns, such as buying patterns.

For example, when a user buys a particular product with an online vendor, for example Amazon, its recommender system may also suggest other products of interest to you. Or, for example, when a user creates a radio “station” on an online music provider (such as Pandora) to track a particular artist, it may play songs by the artist but also other songs deemed similar by its recommender system. These systems may use various algorithms to filter information, such as k-nearest neighbor or a Pearson Correlation.

In addition, several recommender systems look at a user's social network to propose recommendations based on the behavior of the user's friends. Such recommenders may use collaborative filtering algorithms that track a user's activity, preferences, and/or behavior to predict the user's similarity to other users of the system. These algorithms attempt to model the social process of asking a friend or contact for a recommendation.

### BRIEF DESCRIPTION OF THE DRAWINGS

FIG. 1 is an example block diagram of an enhanced content server environment that incorporates an example Security Based Recommender according to example embodiments.

FIG. 2 is an example block diagram of security group organization according to example embodiments.

FIG. 3 is an example flow diagram illustrating logic for providing security based recommendations using a file server.

FIG. 4 is an example flow diagram illustrating logic for providing recommendations using an example embodiments of a Security Based Recommender.

FIG. 5 is an example flow diagram illustrating logic for providing security based recommendations using a Web server.

FIG. 6 is an example block diagram of a computing system for practicing embodiments of an enhanced content server using a Security Based Recommender.

### DETAILED DESCRIPTION

Embodiments described herein provide enhanced computer- and network-based methods, techniques, and systems for a recommender system, e.g., for content servers, that uses security group membership as the basis for determining user similarity. Example embodiments provide a Security Based Recommender (“SBR”) or Security Based Recommender System (“SBRS”), which enables content providers such as content servers, including file servers, web servers, and the like, to recommend content based upon the security parameters of the requesting requester (user, code, logic, or other mechanism for providing a request). In particular, upon request for a recommendation, an enhanced content provider, through the use of the SBR, provides indications of similar content based upon the security group membership of the requestor. The SBR determines similar content by determining what content was accessed by others (e.g., other users, code, logic, or the like) within the security group membership of the requester. For example, if the requester is a member of the “accounting” security group, the SBR might propose a list of files of interest based on which files other members of the accounting group have recently accessed. Also, the recommendations may be ranked or filtered, for example based upon the security group membership hierarchy and “degrees of separation.” For example, content accessed by others in the same accounting group membership but not the immediate subgroup (e.g., payroll) may be ranked (e.g., rated, sorted, listed, or the like) or filtered differently than content accessed by others in the immediate subgroup. In addition, similarity may be a combination of recommendations based upon security group and other types of recommendations, such as social network filtering, statistical based filtering, or the like.

For the purposes used herein, the term “user” or “requester” refers to the code requesting the recommendation, for example, from the content server. It may mean the code used to implement the UI control in a browser, for example, or other code, that eventually translates to a request of the server to provide a recommendation.

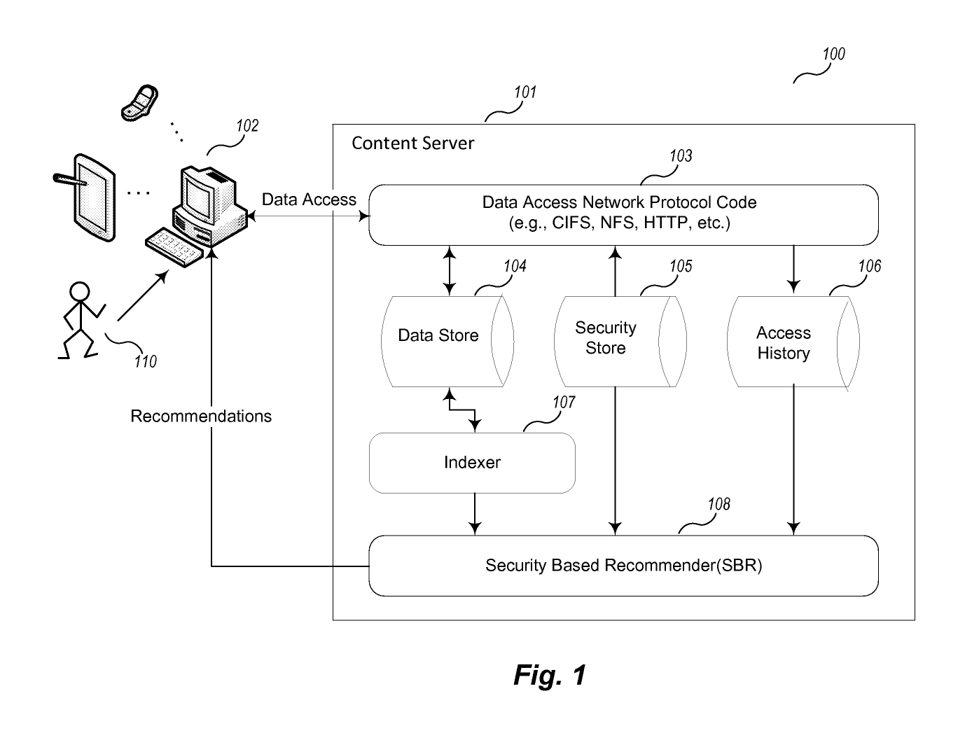

FIG. 1 is an example block diagram of a content server environment that incorporates an example Security Based Recommender according to example embodiments. Content server environment 100 comprises an enhanced content server 101 and a requester computing system 102. In example embodiments, the enhanced content server 101 comprises one or more functional components/modules that work together to provide security based recommendations. Specifically, the enhanced content server 101 comprises data access network protocol code 103, one or more data repositories, such as data store 104, a security store 105, an access history store 106, an indexer 107, and the security based recommender (SBR) 108. In some example embodiments, the enhanced content server 101 is implemented in a distributed manner and one or more of these components is available externally and communicates via standard or proprietary interprocess communication protocols. For the purposes described herein, the enhanced content server 101 may be a file server such as a Windows or a Unix/Linux file server, a web server such as an Apache web server, or any other type of enhanced content server that utilizes some sort of security group membership mechanism.

In operation, a user 110 accesses (e.g., requests for access) one or more data files from the enhanced content server 101 using a requester computing device 102 (requester) and requests recommendations from the enhanced content server 101. This device may be a desktop computing system or notebook computer but it may be a server, a tablet, a cellular phone, or any other computing device that supports the necessary network protocols to communicate with the enhanced content server. The requester 102 may make requests on behalf of users and receive results, such as from a computing program, with or without direct user involvement from a human being.

The enhanced content server 101 receives protocol messages from the requester 102 (and provides data access by decoding and acting on these messages. The messages are received via data access network protocol code 103. When the enhanced content server 101 is a file server, the data access network protocol code 103 may be CIFS and/or NFS, two exemplary file server protocols. When the enhanced content server 101 is a web server, the data access network protocol code 103 may be an HTTP server.

To provide data access, the enhanced content server 101 typically consults its security store 105 to evaluate whether the accessing requester 102 has sufficient privileges to access the requested data. When the enhanced content server 101 is a file server, the security store 105 may be implemented by an external directory server such as Microsoft Active Directory or the Oracle/Sun Network Information Service.

After validating access, the enhanced content server 101 then retrieves or stores information in its data store 104 and logs information describing the operation in its access history store 106. The access history store 106 keeps track of who accessed what data, when the access occurred, and the type of access that was performed, for example, reading, writing or deleting information. Other information may be also maintained.

In some embodiments, the enhanced content server 101 also comprises an indexer for analyzing the content in the data store 104 and creating an index of the data in the data store 104. These indices (not shown) can be quickly searched to find patterns present in content without having to actually read the data. The indexer 107 may be used by a recommender such as the SBR 108 and by other searching facilities to access data without reading it.

When a recommendation has been requested (and/or at other times), the SBR 108 integrates data from the indexer 107, the security store 105 and the access history store 106 to determine what indications to data in the data store 104 to return as recommendations to the requester 102. For example, if user 110 reads a particular file, the SBR 108 may look for other files (data) that has similar contents (based on information from the indexer 107) that have been read by users in the same security groups as the accessing user 110. The SBR 108 reads the security store 105 to find users in the same security groups and reads the access history 106 to find what data they've been accessing.

Content servers such as enhanced content server 101 (especially file servers) frequently provide an access control mechanism for restricting access to privileged information. For example, if the accounting group is storing payroll information on the file server, this information should not be accessible by users who are not authorized to see that information. Financial information published on a Web server might also be restricted as per Sarbanes-Oxley regulations to senior management. To enforce access controls, content servers typically allow access to be granted or denied to individuals (“John Doe”) or to collections of individuals (“Accounting” or “Exec”). A collection of individuals is termed a “security group.”

Frequently, security groups are also allowed to contain other security groups in addition to or instead of individuals. “Accounting” for example, may contain “John Doe”, “Accounts Receivable” and “Accounts Payable” where the last two members are other security groups. The security groups employed by a content server constitute an implicit declaration of similarity between the individuals in those groups. The hierarchy of “nested” security groups (groups that contain other groups—subgroups) may also implicitly suggest degrees of similarity. That is there may be a “familial” relationship (such as parent-child) that suggests degrees of similarity.

For example, if Susan Smith and Fred Jones are members of the Accounts Payable subgroup (which is a member of the Accounting group in a child-parent relationship), they may be considered more similar to each other than to John Doe who is a member of the Accounting group, although all three individuals are members of the Accounting security group. File server security groups can be a rich source of similarity metrics when designing a recommender system such as SBR 108.

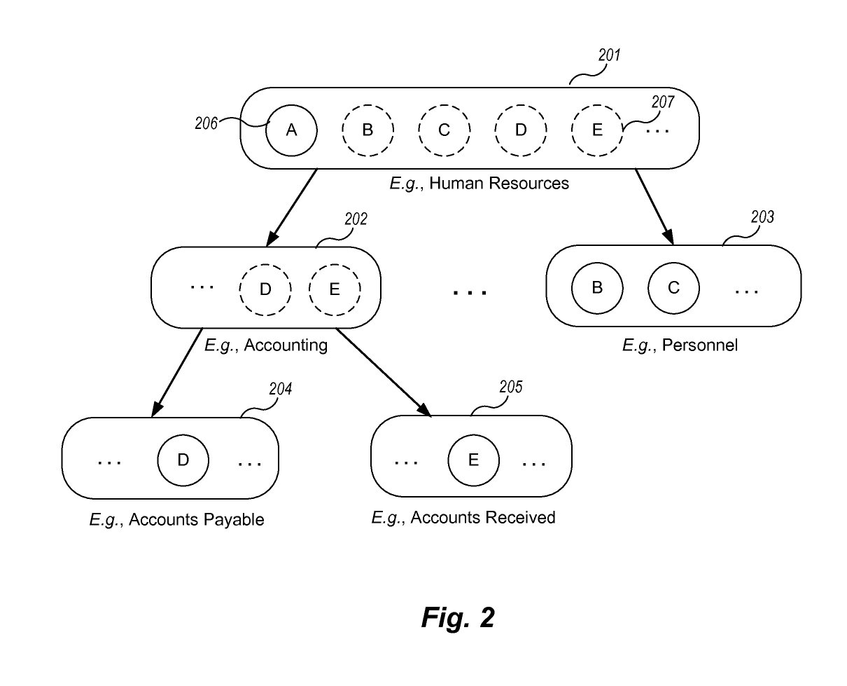

FIG. 2 is an example block diagram of security group organization according to example embodiments. In FIG. 2, security group 201 is a parent security group, such as “Human Resources,” which contains two subgroups—security group 202 “Accounting” and security group 203 “Personnel.” The letters “A” 206 through “E” 207 represent users that are members of each security group, either directly (solid line) or indirectly (dashed line) such as through subgroup membership. As described above, for many reasons, including for example governmental regulations, the files that are accessible by the users who belong to the Accounting security group 202 are not necessarily accessible to the users who belong to the Personnel security group 203. Similarly, the Accounting security group 202 contains two subgroups—security group 204 “Accounts Payable” and security group 205 “Accounts Receivable.” All of subgroups 202-205 are members of the Human Resources security group 201, yet the needs of the users in the various subgroups are not the same. Consequently, the similarities computed by an exemplary recommender such as SBR 108 may be different based upon the closeness (e.g., proximity, distances, likeness, etc.) of the security groups to which users belong.

User security groups are typically maintained by a content server or by an external authentication and authorization system such as Microsoft Active Directory or the Oracle/Sun Network Information Service (NIS) in communication with the content server. As described above, two common types of a content server include file servers, such as Microsoft Windows or Unix/Linux servers, and web servers, such as an Apache web server.

In example file server embodiments, the underlying operating system is typically responsible for providing protocols and mechanisms for accessing data stored in shared file systems (file servers). For example, the Microsoft Windows operating system (Windows) allows virtual drive letters (“D:”, “E:”, etc.) to be mapped to file “shares” on shared file servers. Windows access data on these servers by utilizing the “SMB” (Server Message Block) network protocol, also known as the “CIFS” protocol (Common Internet File System). UNIX and Linux can access file servers by using SMB/CIFS but also by using the “NFS” (Network File System) and “FTP” (File Transfer Protocol) protocols.

Regardless of whether a file server is accessed via SMB/CIFS, NFS, FTP or some other data access protocol, file servers typically provide some form of access control to restrict access to data. These access control mechanisms allow data to be restricted to particular users or groups of users (e.g., security groups). An SMB/CIFS-based file server, for example, allows an “access control list” (ACL) to be associated with a file in order to control who has access to the file. Each “access control entry” (ACE) in the ACL identifies a particular user or group and the type of access that the user or group is allowed. An ACL, for example, might allow all members of the “Accounting” security group 202 in FIG. 2 to read a file but only allow “Joe Smith” to write to it. An NFS file server (e.g., versions older than 4.0) typically provides a more restricted form of access control (“Posix ACLS”), but also allows access to be based on security group membership as described above with reference to FIG. 2.

In order for a file server to restrict access to a file, it must therefore be made aware of the identity of the user trying to access the file and the security groups to which the user belongs. This information is typically established when the user connects and authenticates with the file server.

Different techniques are used in different operating systems for determining the security rights of the user when a user connection is established and authenticated. For example, on a UNIX/Linux computer, user account information is typically stored in special files known to the operating system. The files “/etc/passwd” and “/etc/group” maintain information about user accounts and the groups to which those users belong. These files are updated when security information (e.g., ACLs) is changed. Users and groups have readable names, but also numeric identifiers. A user logged into a UNIX/Linux computer can use the “id” command available as part of the UNIX/Linux user interface (the Shell) to list his/her user id number and the groups to which he/she belongs (listed by name and group number). UNIX/Linux also allows account information to be stored on a central “Network Information Service” (NIS) server. The form of the information is similar.

Like UNIX/Linux, Windows computing environments support “local” accounts or accounts stored in a centralized Microsoft Active Directory server. Local accounts are specific to a particular computer while centralized accounts are shared across the organization. Regardless of whether an account is local or global, Windows supports the concept of security groups as well as user accounts and assigns both of them security identifiers (SIDS).

When a user accesses a shared file using SMB/CIFS, NFS or other file sharing protocol, the user must typically authenticate himself/herself with the file server. This will typically involve some security protocol (for example, Kerberos) and results in the file server receiving an identifier that is associated with the user and a list of identifiers that enumerate the user's security group memberships. This information can then be used to evaluate and compare ACLS associated with files to determine whether the user has appropriate access to those files.

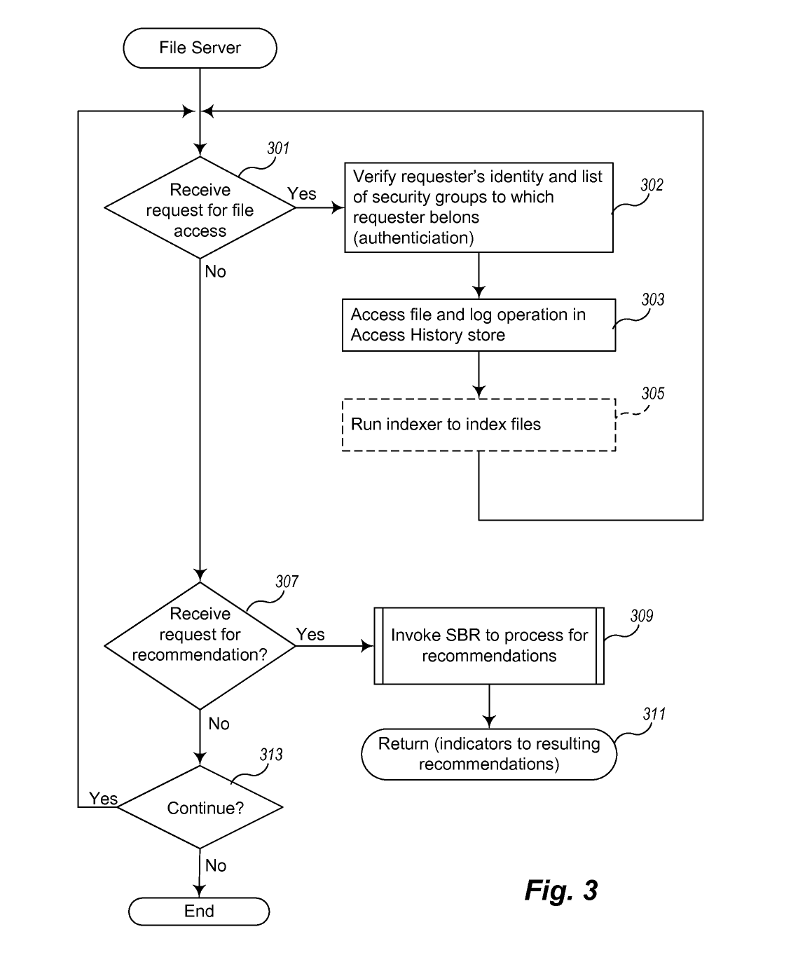

Once the particulars of the security group system are known, a Security Based Recommender (SBR), such as SBR 108, may be used in a file server, such as enhanced content server 101, to determine similarities based upon security access in order to make recommendations to a requester 102, such as shown in FIG. 1. FIG. 3 is an example flow diagram illustrating logic for providing security based recommendations using a file server. As described with respect to FIG. 1, for a typical file access, the file server receives notification of a user identity and a list of security groups to which the user belongs, determines whether to allow access to the requested file, and, if so, provides the access and makes a note of the operation in its Access History store (e.g., Access History store 106). Sometime later (or even before a file is requested), when the requestor asks for a recommendation for other data (e.g., similar files), the file server invokes the SBR to return indications of such files to the requester.

Specifically, in block 301, the file server determines whether it has received a request to access a file. If so, the logic continues in block 302, other continues in block 307 to process the next request. In block 302, the file server verifies the requester's identity (for example, that received during authentication upon connection of the requester) and determines the list of security groups to which the requester belongs. This determination is typically performed as part of the authentication process but may be determined again at other times. In block 303, the logic provides access to the file if the security indicates that access is proper and logs the operation in the Access History store. In block 305, optionally, at this time and/or at other times linked or not linked to a particular request, the file server may run an indexer (such as indexer 107 in FIG. 1) to index the files for quick “keyword” (or phrase, or sentence) matching. Indexing may be run at determined time intervals, predetermined times, or otherwise as convenient, or not at all. The logic then continues to the beginning of the loop to block 301.

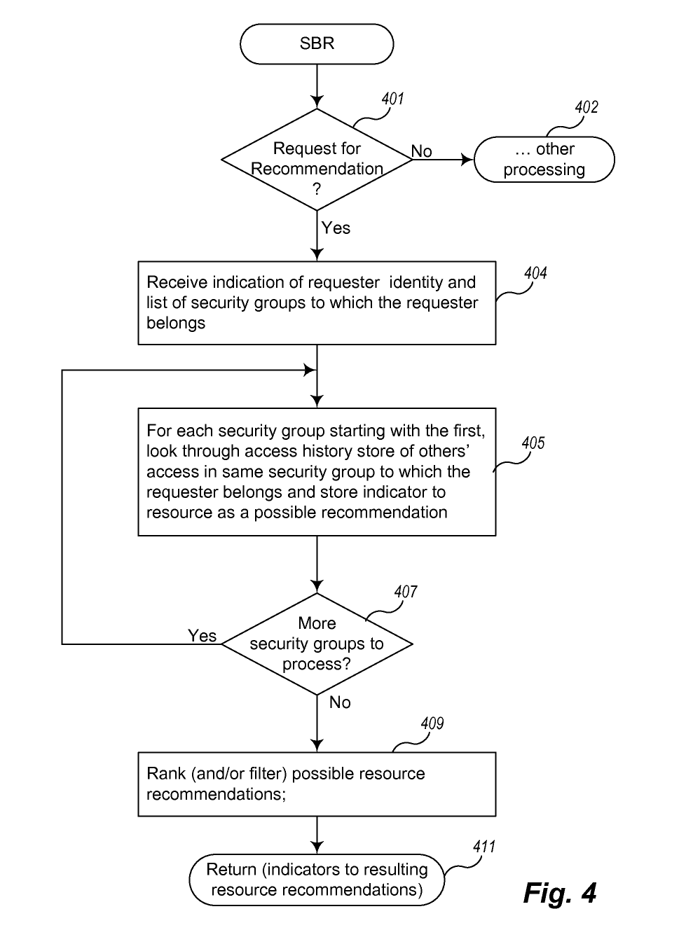

In block 307, the file server logic determines whether it has received a request from the requester for a recommendation. If so, the file server invokes the SBR as described with reference to FIG. 4 to search for recommendations and returns them at block 311. Otherwise, the file server logic continues in block 313 to determine whether there is other processing to perform, and if so, continues to the top of the loop to block 301, otherwise ends.

FIG. 4 is an example flow diagram illustrating logic for providing recommendations using example embodiments of a Security Based Recommender for an enhanced content server. This logic may be performed, for example, using the SBR 108 illustrated in FIG. 1. As will be described further below, this logic is also invoked by an enhanced content server in the form of a Web Server, the only difference being for file servers the resources recommended are typically files, whereas the resources for a Web server may be just data blocks.

Specifically, in block 401, the SBR determines whether it has received a request for a recommendation, and, if so, continues to block 403, otherwise performs other processing (block 402). In block 403, the SBR logic receives an indication of the requester identity and a list of security groups to which the requester belongs. In some embodiments, the SBR logic may determine this on its own by accessing the ACLs and through other mechanisms. In other embodiments, this information is forwarded to the SBR.

In blocks 405-407, the logic performs a loop for each security group to which the request belongs starting with the first. In block 405, for each such security group, the logic determines, for example, by examining (e.g., analyzing, determining, etc.) the Access History store, which other files have been accessed by others that share the identified security group. This information may be stored, for example, as a temporary collection result in order to filter or rank the information later. In addition, other information for use in filtering or ranking may be also stored.

In block 407, the logic determines whether there are other security groups to process and, if so, returns to the beginning of the loop in block 405, otherwise continues in block 409.

In block 409 the SBR logic ranks and/or filters the previously stored possible recommendations. Many ways are available for ranking and/or filtering the possible recommendations. For example, in block 405, the logic can keep track of a count of the number of accesses to each determined resource (e.g., files and/or data) and this count may be used in block 409 to rank the possible recommendations. In addition, the logic may use “degrees of separation” (proximity) in security group membership to further score resource relevance. For example, those resources (e.g., files and/or data) in closer proximity may be scored higher. Also, if the file server has been performing content indexing in addition to storing access history, the SBR (or other components of the file server) can look at the most recent resource or resources accessed by the requester, determine its keywords (using, for example, term frequency/inverse document frequency statistics or other statistical measures), and then look for other resources in its index that contain similar keywords. The possible recommendations derived in block 407 and ranked in block 409 can then be blended with this indexer information. In addition, information available through other techniques of assessing similarity of resources may be blended (e.g., combined, intersected, coalesced, etc.) with the possible recommendations derived in blocks 407 and 409. Also, the possible recommendations derived in blocks 407 and 409 may be ranked and/or filtered according to a set of criteria, for example, recency.

In block 411, the logic returns indicators to the resulting recommended resources (e.g., files and/or data).

As mentioned, another common type of a content server is a Web server. Use of Web servers to share information is increasingly prevalent both with public Internet servers and with company-internal intranet servers. Information can be obtained from these web servers using a client side application, for example, a Web browser (e.g., Apple Safari, Mozilla Firefox, Microsoft Internet Explorer, and the like). The client application typically uses the HTTP protocol to communicate with the Web server, although other protocols may be incorporated.

As with file servers, Web servers typically provide some mechanism for access control. As one example, the Microsoft IIS Web server employs ACLS in exactly the same form as used by SMB/CIFS file servers. Files and directories accessed through HTTP are subject to ACL enforcement as if accessed via SMB/CIFS. Web access to files and directories can be restricted on the basis of individual security identities or security group memberships.

The Apache Web server, one of the most popular Web servers in current use, does not use file-based (Posix) access controls but still supports the concept of user security and security group based access. Apache provides the “htaccess” and “htdigest” programs to allow Web server administrators to create files containing user accounts. Administrators can also create group files naming groups of multiple users that are to be treated in a common fashion. These user and group accounts can then be used in Apache configuration files to restrict access to data in particular directories.

Once the particulars of the security group system are known, a Security Based Recommender (SBR), such as SBR 108, may be used in a Web server, such as enhanced content server 101, to determine similarities based upon security access in order to make recommendations to a requester 102, such as shown in FIG. 1. As described in FIG. 1, for a typical data access, the Web server receives notification of a the user identity and a list of security groups to which the user belongs, determines whether to allow access to the requested resource, and, if so, provides the access and makes a note of the operation in its Access History store (e.g., Access History store 106). Sometime later (or even before a resource is requested), when the requestor asks for a recommendation for other data (e.g., similar resources), the Web server invokes the SBR to return indications of such resources to the requester.

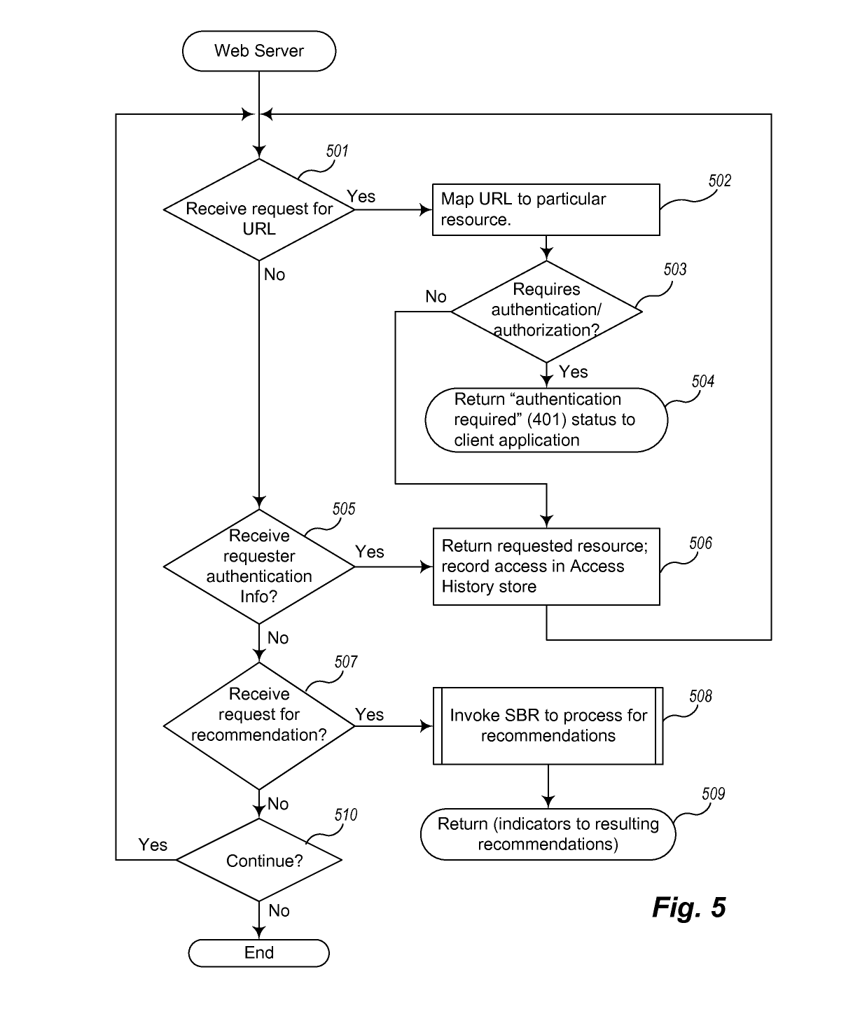

Once the particulars of the security group system are known, a Security Based Recommender (SBR), such as SBR 108, may be used in a file server, such as enhanced content server 101, to determine similarities based upon security access in order to make recommendations to a requester 102, such as shown in FIG. 1. FIG. 5 is an example flow diagram illustrating logic for providing security based recommendations using a Web server. As described with respect to FIG. 1, for a resource access that requires authentication and/or authorization of the requester, the Web server receives notification of the user identity and a list of security groups to which the user belongs, determines whether to allow access to the requested resource, and, if so, provides the access and makes a note of the operation in its Access History store (e.g., Access History store 106). When the requestor asks for a recommendation for other similar resources), the Web server invokes the SBR to return indications of such resources to the requester.

Specifically, in block 501, the Web server determines whether it has received a request to access a resource, for example, a uniform resource locator (“URL,” sometimes referred to as a uniform resource identifier “URI”). If so, the logic continues in block 502, other continues in block 504 to process the next request.

In block 502, the Web server determines whether the resource requires user authentication/authorization, and if so, continues in block 504, otherwise continues in block 506. In block 504 the Web server returns a “authentication required” or equivalent status (e.g., a “401” status) to the client application, e.g., a Web browser. The client application either requests such information from the user or attempts to use already entered information, or some combination of both and then retries the request to the Web server.

In block 505, the Web server receives the requester authentication information, verifies it, as needed, and determines the list of security groups to which the requester belongs. This determination is typically performed as part of the authentication process but may be determined again at other times.

In block 506, the logic provides access to the resource if the security indicates that access is proper and logs the operation in the Access History store. The logic then returns to the beginning of the loop to block 501.

Although not shown, as in the file server case, the Web server may run an indexer (such as indexer 107 in FIG. 1) to index the resources for quick “keyword” (or phrase, or sentence) matching. Indexing may be run at determined time intervals, predetermined times, or otherwise as convenient, or not at all.

In block 507, the logic determines whether it has received a request from the requester for a recommendation. If so, the server invokes the SBR as described with reference to FIG. 4 to search for recommendations and returns them at block 509. Otherwise, the logic continues in block 510 to determine whether there is other processing to perform, and if so, continues to the top of the loop to block 501, otherwise ends.

Regardless of the particular security mechanism used or particulars regarding the content server, the Security Based Recommender (SBR) may be incorporated into an enhanced content server to determine similarities based upon security access in order to make recommendations to a requester such as shown in FIGS. 1-5. In other example embodiments, the SBR may be provide external to the content recommender, as long as it has access to the security group and resource access information.

Although the techniques of a security based recommender are generally applicable to any type of content server, the phrase “file server,” “web server,” “content server,” and the like is used generally to imply any type of computing system that delivers content to users. In addition, the concepts and techniques described are applicable to any type of server of content as long as the server somehow employs the concept of “security groups” to control access to information and if a recommender uses these security groups in some manner to develop its recommendations.

Also, although certain terms are used primarily herein, other terms could be used interchangeably to yield equivalent embodiments and examples. For example, it is well-known that equivalent terms can be used interchangeably. In addition, terms may have alternate spellings which may or may not be explicitly mentioned, and all such variations of terms are intended to be included.

Example embodiments described herein provide applications, tools, data structures and other support to implement a Security Based Recommender to be used for providing content recommendations based upon security group information. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the code flow, different code flows, etc. Thus, the scope of the techniques and/or functions described are not limited by the particular order, selection, or decomposition of steps described with reference to any particular routine.

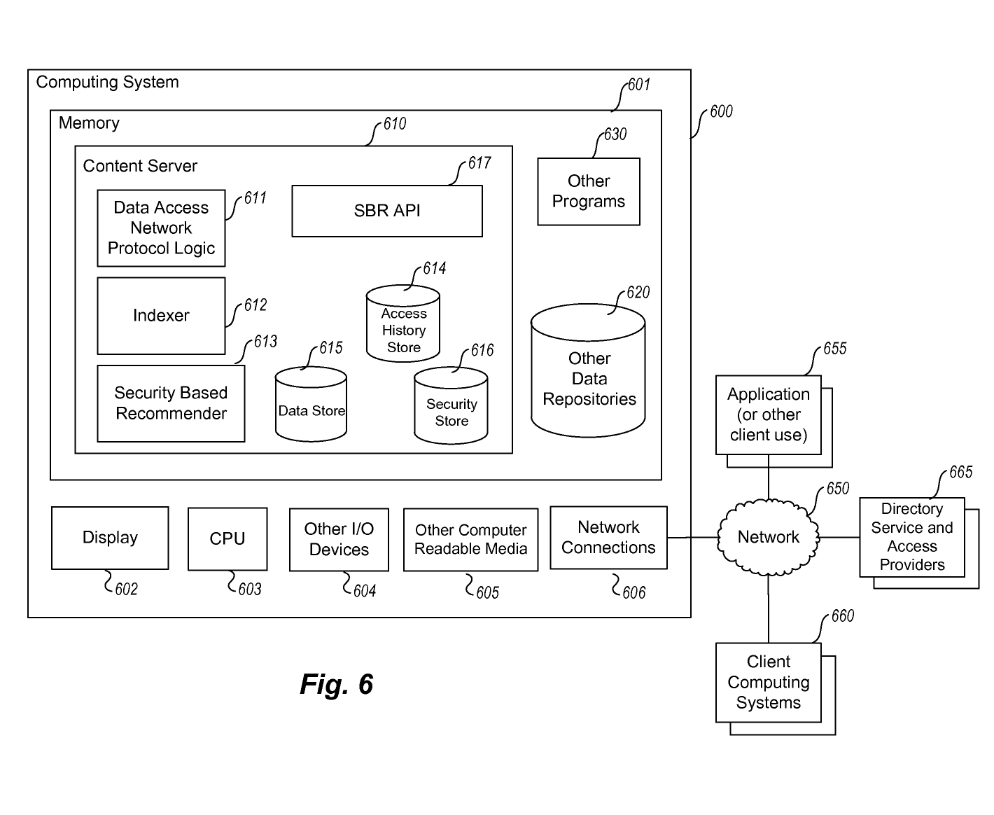

An exemplary enhanced content server, whether a file server, Web server, or other content server may be implemented by a general purpose or a special purpose computing system suitably instructed. FIG. 6 is an example block diagram of an example computing system that may be used to practice embodiments of a enhanced content server using a Security Based Recommender as described herein. Further, the enhanced content server and/or SBR may be implemented in software, hardware, firmware, or in some combination to achieve the capabilities described herein.

The computing system 600 may comprise one or more server and/or client computing systems and may span distributed locations. In addition, each block shown may represent one or more such blocks as appropriate to a specific embodiment or may be combined with other blocks. Moreover, the various blocks of the content server 610 may physically reside on one or more machines, physical and/or virtual, which use standard (e.g., TCP/IP) or proprietary interprocess communication mechanisms to communicate with each other.

In the embodiment shown, computing system 600 comprises a computer memory (“memory”) 601, a display 602, one or more Central Processing Units (“CPU”) 603, Input/Output devices 604 (e.g., keyboard, mouse, CRT or LCD display, etc.), other computer-readable media 605, and one or more network connections 606. The content server 610 is shown residing in memory 601. In other embodiments, some portion of the contents, some of, or all of the components of the enhanced content server 610 may be stored on and/or transmitted over the other computer-readable media 605. The components of the enhanced content server 610 preferably execute on one or more CPUs 603 and manage the generation of security based resource recommendations, as described herein. Other code or programs 630 and potentially other data repositories, such as data repository 620, also reside in the memory 601, and preferably execute on one or more CPUs 603. Of note, one or more of the components in FIG. 6 may not be present in any specific implementation. For example, some embodiments embedded in other software may not provide means for user input or display.

In a typical embodiment, the enhanced content server 610 includes one or more data access network protocol logic 611, one or more indexers 612, and one or more Security Based Recommenders (SBR) 614 as described with reference to FIGS. 1-5. In addition, a Data Store 615, an Access History store 614, and a Security store 616 is provided as described with reference to FIG. 1. In at least some embodiments, the SBR is provided external to the content server and is available, potentially, over one or more networks 650. Other and/or different modules may be implemented. In addition, the content server may interact via a network 650 with application or client code 655 that, e.g., uses results computed by the SBR 613, one or more client computing systems 660, and/or one or more third-party information provider systems 665, such as directory services. Also, of note, the various data stores 614, 615, and/or 616 may be provided external to the content server as well, for example in a knowledge base accessible over one or more networks 650.

In an example embodiment, components/modules of the enhanced content server 610 are implemented using standard programming techniques. In other embodiments, the enhanced content server 610 may be implemented as instructions processed by a virtual machine. In general, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by an enhanced content server implementation.

In addition, programming interfaces to the data stored as part of the enhanced content server 610 (e.g., in the data repositories 614, 615 and 616) or the recommendations provided by the SBR 613 can be available by standard means such as through C, C++, C#, and Java APIs; libraries for accessing files, databases, or other data repositories; through scripting languages such as XML; or through Web servers, FTP servers, or other types of servers providing access to stored data. The data stores 614-616 may be implemented as one or more database systems, file systems, or any other method known in the art for storing such information, or any combination of the above, including implementation using distributed computing techniques.

Also the example enhanced content server 610 may be implemented in a distributed environment comprising multiple, even heterogeneous, computer systems and networks. Different configurations and locations of programs and data are contemplated for use with techniques of described herein. In addition, the server and/or client may be physical or virtual computing systems and may reside on the same physical system. For example, in one embodiment, the indexer 612, the SBR 613, and the security data store 616 are all located in physically different computer systems. In another embodiment, various modules of the enhanced content server 610 are hosted each on a separate server machine and may be remotely located from the tables which are stored in the repositories 614-616. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of a security based recommender in an enhanced content server.

Furthermore, in some embodiments, some or all of the components of the enhanced content server may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 61/538,525, entitled “RECOMMENDER SYSTEM FOR A CONTENT SERVER BASED ON SECURITY GROUP MEMBERSHIP,” filed 23 Sep. 2011, is incorporated herein by reference, in its entirety.

From the foregoing it will be appreciated that, although specific embodiments have been described herein for purposes of illustration, various modifications may be made without deviating from the spirit and scope of the invention. For example, the methods and systems for performing security based recommendations discussed herein are applicable to other architectures other than a Windows or a UNIX/Linux architecture. Also, the methods and systems discussed herein are applicable to differing protocols, communication media (optical, wireless, cable, etc.) and devices (such as wireless handsets, electronic organizers, personal digital assistants, portable email machines, game machines, tablets, pagers, navigation devices such as GPS receivers, etc.).

1. A computer-implemented method for determining recommendations of resources in a computing system, comprising:
receiving, from a requester, a request for a recommendation to one or more resources of a content server;
determining a security group of which the requester is a member;
determining the requested recommendation of the one or more resources by analyzing the access history of other members of the determined security group to generate a set of recommended resources; and
returning indications to the recommended resources.

2. The method of claim 1, further comprising:
ranking the generated set of recommended resources.

3. The method of claim 1 wherein the ranking the generated set of recommended resources ranks each resource based upon a number of accesses of each resource.

4. The method of claim 1, further comprising:
filtering the set of recommended resources using a set of criteria.

5. The method of claim 1 wherein the determined security group is part of a hierarchy of security groups, and wherein the determining the requested recommendation of the one or more resources by analyzing the access history of other members of the determined security group to generate a set of recommended resources considers a position of the determined security group in the hierarchy to assess a degree of similarity between users in the same security group.

6. The method of claim 5 wherein users indirectly belonging to the same parent security group but different base security groups are considered less similar.

7. The method of claim 1 wherein the determining the requested recommendation of the one or more resources by analyzing the access history of other members of the determined security group to generate a set of recommended resources further comprises:
analyzing an access history of other members of the determined security group to generate a set of initial recommended resources;
determining one or more previously accessed resources of the requester;
receiving a set of similar resources to the determined one or more previously accessed resources of the requester from an index of resources, based upon keyword matching of the one or more previously accessed resources to the index; and
combining the similar resources with the set of initial recommended resources to generate a set of recommended resources.

8. The method of claim 7 wherein the combining the similar resources with the set of initial recommended resources to generate a set of recommended resources ranks each resource.

9. The method of claim 7 wherein the combining the similar resources with the set of initial recommended resources to generate a set of recommended resources filters the set of recommended resources using a set of criteria.

10. The method of claim 1 wherein the one or more resources are files.

11. The method of claim 1 wherein the one or more resources are data accessible using one or more uniform resource identifiers.

12. The method of claim 1 wherein the determining the security group of which the requester is a member comprises:
determining the security group of which the requester is a member by consulting an external directory service.

13. The method of claim 1 wherein the returning indications to the recommended resources further comprises:
returning indications to the recommended resources through a web-based protocol.

14. The method of claim 13 wherein the web-based protocol is HTTP.

15. The method of claim 1 wherein the returning indications to the recommended resources further comprises:
returning indications to the recommended resources through a networked file server protocol.

16. The method of claim 15 wherein the networked file server protocol is at least one of CIFS and/or NFS.

17. The method of claim 1 wherein the content server is a file server.

18. The method of claim 1 wherein the content server is a Web server.

19. A non-transitory computer-readable medium containing contents that, when executed, perform a methods of comprising:
receiving, from a requester, a request for a recommendation to one or more resources of a content server;
determining a security group of which the requester is a member;
determining the requested recommendation of the one or more resources by analyzing the access history of other members of the determined security group to generate a set of recommended resources; and
returning indications to the recommended resources.

20. The computer-readable medium of claim 19 wherein the medium is a computer memory and the contents are computer instructions stored in the memory.

21. The computer-readable medium of claim 19 wherein the content server is a file server or a Web server.

22. The computer-readable medium of claim 19 wherein the determined security group is part of a hierarchy of security groups, and wherein the determining the requested recommendation of the one or more resources by analyzing the access history of other members of the determined security group to generate a set of recommended resources considers a position of the determined security group in the hierarchy to assess a degree of similarity between users in the same security group.

23. A computing system comprising:
a memory; and
a security based recommender, stored in the memory, and that is configured, when executed, to:
receive a request for a recommendation to one or more resources of a content server via a network protocol handler; and
determine recommended resources using security group based similarity by analyzing the access history of other members of the determined security group to generate a set of recommended resources.

24. The computing system of claim 23 wherein the security based recommender is a component of the content server.

25. The computing system of claim 23 wherein the security based recommender is external to the content server.

26. The computing system of claim 23 wherein the content server is a file server.

27. The computing system of claim 23 wherein the content server is a Web server.
